(19) United States
(12) Patent Application Publication
(10) Pub. No.: US 2026/0084598 A1
(43) Pub. Date: Mar. 26, 2026

(54) AIR BLADDER AND AIR BLADDER SET

(71) Applicant: TOYOTA BOSHOKU KABUSHIKI KAISHA, Aichi (JP)

(72) Inventors: Hideki YODA, Kariya-shi (JP); Kai MITSUYA, Kamakura-shi (JP)

(73) Assignee: TOYOTA BOSHOKU KABUSHIKI KAISHA, Aichi (JP)

(21) Appl. No.: 19/323,119

(22) Filed: Sep. 9, 2025

(30) Foreign Application Priority Data
Sep. 25, 2024 (JP) 2024-166402

(51) Int. Cl. B60N 2/66; B60N 2/90

(52) U.S. Cl. CPC B60N 2/665; B60N 2/914

(57) ABSTRACT

An air bladder for use in a vehicle seat includes an air chamber, a sheet member, a communication hole, and at least one guide portion. The air chamber is configured to be filled with air. The sheet member separates the air chamber from an exterior. The communication hole is formed in a central portion of the sheet member and allows communication between the air chamber and the exterior. The at least one guide portion is located adjacent to an air chamber side of the sheet member. The at least one guide portion is configured to guide air that flows into the air chamber from the communication hole toward a corner portion of the air chamber.

### CROSS-REFERENCE TO RELATED APPLICATIONS

This application claims the priority of Japanese Patent Application No. 2024-166402 filed on September 25, 2024 with the Japan Patent Office, the disclosure of which is incorporated herein by reference.

### BACKGROUND

The present disclosure relates to an air bladder and air bladder set for use in a vehicle seat.

For example, Japanese Unexamined Patent Application Publication No. 2021-024557 discloses an air bladder which includes an annular rib that surrounds a communication hole communicated with the interior of the air bladder. The annular rib includes a cut-out portion.

### SUMMARY

The present disclosure provides an example of a technique for facilitating smooth inflation of an air bladder comprising an air chamber to be filled with air.

The air bladder for use in a vehicle seat desirably comprises the following elements, for example. The elements include an air chamber, a sheet member, a communication hole, and at least one guide portion. The air chamber has a flat polygonal shape and is configured to be filled with air. The sheet member separates the air chamber from an exterior. The communication hole is formed in a central portion of the sheet member and allows communication between the air chamber and the exterior. The at least one guide portion is located adjacent to an air chamber side of the sheet member. The at least one guide portion is configured to guide air that flows into the air chamber from the communication hole toward a corner portion of the air chamber.

In the air bladder configured as above, air that flows into the air chamber from the communication hole is guided to a corner portion of the air chamber. Thus, it is possible to reliably inflate the corner portion, which is difficult to inflate. This makes it possible to facilitate smooth inflation of the air bladder.

The air bladder may be configured, for example, as described below. Each of the at least one guide portion is desirably formed as an elongated protrusion on an interior-facing surface of the sheet member. The interior-facing surface faces the air chamber. The elongated protrusion desirably extends in a direction inclined with respect to a radial direction of the communication hole.

In the air bladder configured as above, it is possible to provide an extended length to the elongated protrusion of the guide portion. Thus, when a load to flatten the air chamber is applied to the air bladder, it is possible to inhibit one side of the interior-facing surface of the air bladder from coming into contact with or adhering to the other side.

In other words, it is possible to provide a greater length to the guide portion in the air bladder as compared with a configuration where a guide portion extends in the radial direction. Thus, even when a load to flatten the air chamber is applied to the air bladder, it is possible to sufficiently bear the load.

Since the aforementioned configuration can inhibit one side of the interior-facing surface of air bladder from coming into contact with or adhering to the other side, even when a load to flatten the air chamber is applied to the air bladder, it is possible to reliably supply air from the communication hole into the air chamber and quickly inflate the air bladder.

The elongated protrusion desirably extends in such a way as to form a vortex around the communication hole. This configuration creates a swirling component in the airflow toward the corner portion in addition to a component toward the corner portion.

As a result, air that has reached the corner portion readily changes its direction due to the swirling component. Thus, it is possible to effectively generate the Coandă effect. This makes it possible to distribute air throughout the air chamber. Thus, it is possible to smoothly and quickly inflate the air bladder.

The air bladder for use in a vehicle seat desirably comprises, for example, the following elements. The elements may include an air chamber, a sheet member, a communication hole, and at least one guide portion. The air chamber may be configured to be filled with air. The sheet member may separate the air chamber from an exterior. The communication hole may be formed in a central portion of the sheet member and allow communication between the air chamber and the exterior. The at least one guide portion may be located adjacent to an air chamber side of the sheet member. The at least one guide portion is configured to guide air that flows into the air chamber from the communication hole toward an outer periphery of the air chamber. Each of the at least one guide portion may be formed as an elongated protrusion on an interior-facing surface of the sheet member. The interior-facing surface faces the air chamber. The elongated protrusion may extend in a direction inclined with respect to a radial direction of the communication hole. The air bladder configured as above can facilitate smooth inflation of the air bladder.

The elongated protrusion desirably extends in such a way as to form a vortex around the communication hole. This configuration makes it possible to distribute air throughout the air chamber, and thus possible to smoothly and quickly inflate the air bladder.

The air chamber is desirably flat. This configuration can facilitate smooth inflation of the flat air bladder.

The sheet member desirably includes a first portion and a second portion arranged to face each other with the air chamber interposed therebetween. The communication hole is desirably formed in a central portion of the first portion. The at least one guide portion is desirably located on the interior-facing surface of the first portion. This configuration can facilitate smooth inflation of the flat air bladder.

The at least one guide portion desirably includes a plurality of guide portions. Two adjacent guide portions of the plurality of guide portions desirably define an airflow path, and the airflow path desirably has an outlet width larger than its inlet width.

An air bladder set for use in a vehicle seat desirably comprises, for example, the following elements. The elements may include the aforementioned air bladder and an additional air bladder. The additional air bladder may include a different air chamber configured to be filled with air, and a different sheet member separating the additional air chamber from an exterior. The different air chamber and the different sheet member are respectively different from an air chamber and a sheet member of the aforementioned air bladder. The air chamber of the aforementioned air bladder and the different air chamber of the additional air bladder may be connected via a communication hole of the aforementioned air bladder. This configuration can facilitate smooth inflation of the air bladder.

The air bladder set desirably further comprises a flow port extending from the different sheet member to allow air to be supplied to the air chamber and the additional air chamber. This configuration can facilitate smooth inflation of the air bladder.

### BRIEF DESCRIPTION OF THE DRAWINGS

Some example embodiments of the present disclosure will be described hereinafter with reference to the accompanying drawings, in which:

FIG. 1 is a diagram illustrating a vehicle seat according to a first embodiment;

FIG. 2 is a diagram illustrating an air bladder according to the first embodiment;

FIG. 3 is a sectional view of the air bladder according to the first embodiment;

FIG. 4 is a sectional view of the air bladder according to the first embodiment;

FIG. 5 is a perspective view of the air bladder according to the first embodiment;

FIG. 6 is a plan view of the air bladder according to the first embodiment;

FIG. 7 is a plan view of an area around a communication hole of the air bladder according to the first embodiment;

FIG. 8 is a plan view of an area around a communication hole of an air bladder according to a second embodiment;

FIG. 9 is a plan view of an area around a communication hole of an air bladder according to a third embodiment; and

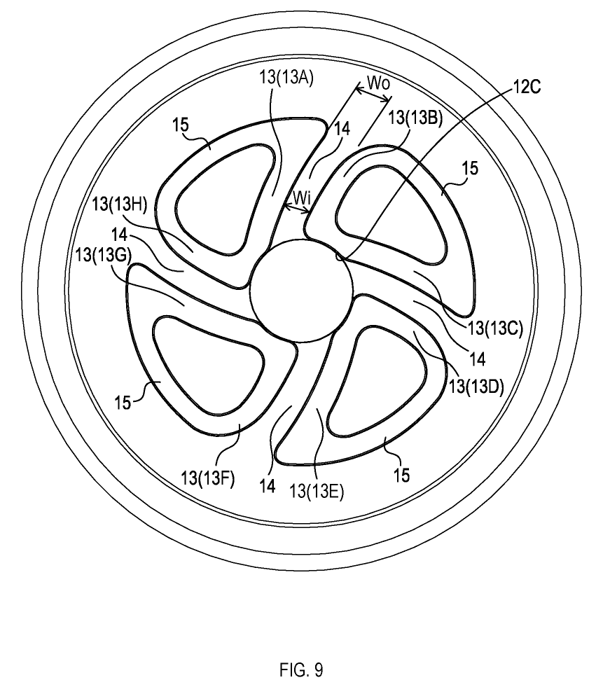

FIG. 10 is a plan view of an air bladder according to a fourth embodiment.

### DETAILED DESCRIPTION OF EXEMPLARY EMBODIMENTS

Following embodiments represent examples of embodiments that fall within the technical scope of the present disclosure. In other words, matters used to specify the invention or the like recited in the claims are not limited to any specific configuration, structure, or the like described in the following embodiments.

The present embodiments show examples where an air bladder according to the present disclosure is applied to a seat provided to be mounted to a vehicle such as a car (hereinafter referred to as “vehicle seat”). Arrows for indicating directions, oblique lines, or the like in each drawing are used to facilitate understanding of mutual relations between the drawings, the shape of members or portions, or the like.

Therefore, orientation of the air bladder is not limited to how the air bladder is oriented in each drawing. The directions in each drawing are provided to show the orientation of the vehicle seat of the present embodiment when it is assembled to a car. A drawing with the oblique lines does not always represent a cross-sectional view.

With respect to at least a member or a portion explained with a reference numeral, at least one of such a member or a portion is provided unless it is described using a term such as “only one of”. In other words, unless it is described using a term such as “only one of”, two or more of such a member or a portion may be provided. The air bladder of the present disclosure includes at least one of elements, such as at least a member or a portion explained with a reference numeral, or a structural component shown in the drawings.

### First Embodiment

### 1. Overview of Vehicle Seat

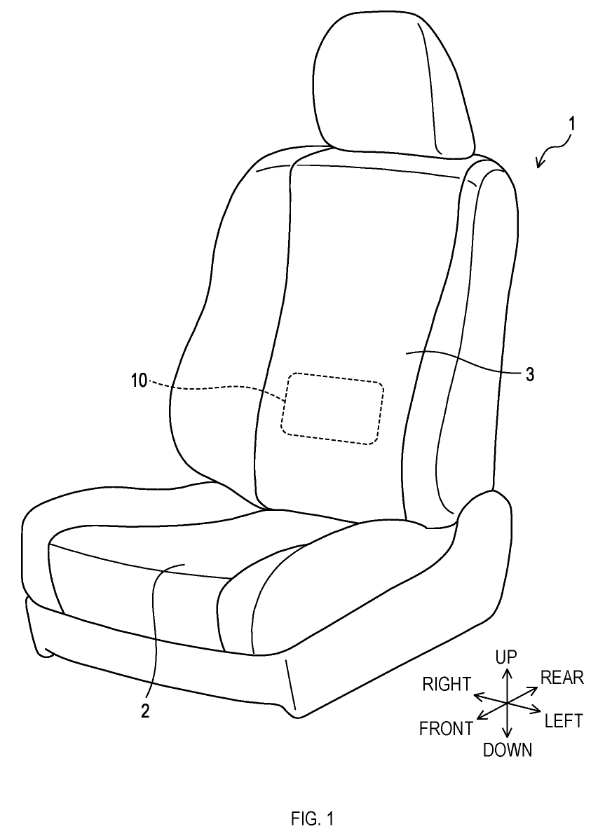

As shown in FIG. 1, a vehicle seat 1 at least includes a seat cushion 2 and a seatback 3. The seat cushion 2 supports an occupant’s buttocks. The seatback 3 supports the occupant’s back.

An air bladder 10 according to the present embodiment is, for example, installed inside a portion of the seatback 3 that is located at a position corresponding to the occupant’s lumbar region. The air bladder 10 receives a supply of high-pressure air, inflating and pressing the occupant’s lumbar region. Thus, the air bladder 10 can provide a refreshing effect to the occupant.

### 2. Configuration of Air bladder

### 2.1 Overview of Air Bladder

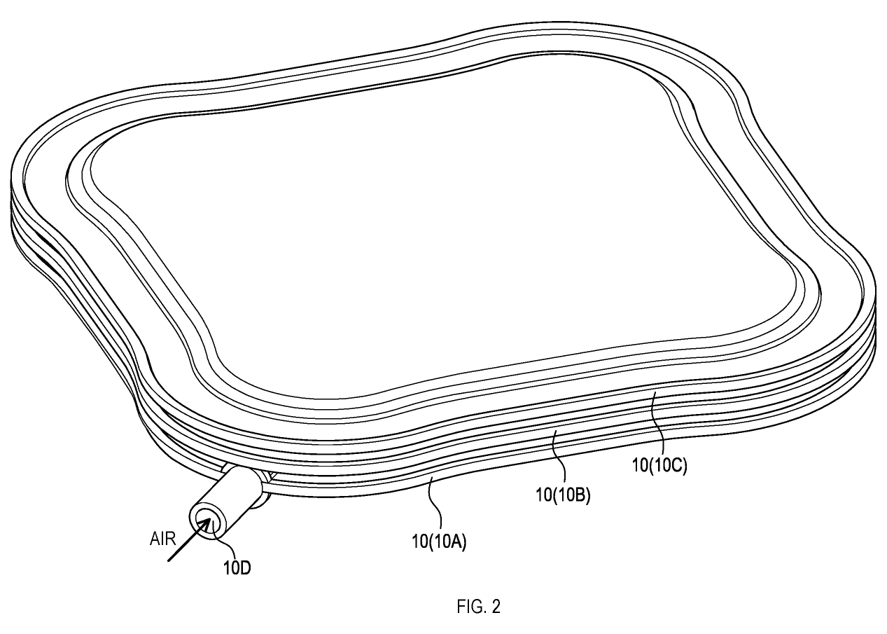

As shown in FIG. 2, two or more (for example, three) of the air bladders 10 are stacked, forming a set of air bladders in the present embodiment. Specifically, air bladders 10A to 10C each have a flat polygonal shape (a flat quadrangular shape in the present embodiment). The air bladders 10A to 10C are stacked in a direction along their thicknesses and formed into one piece by heat fusion.

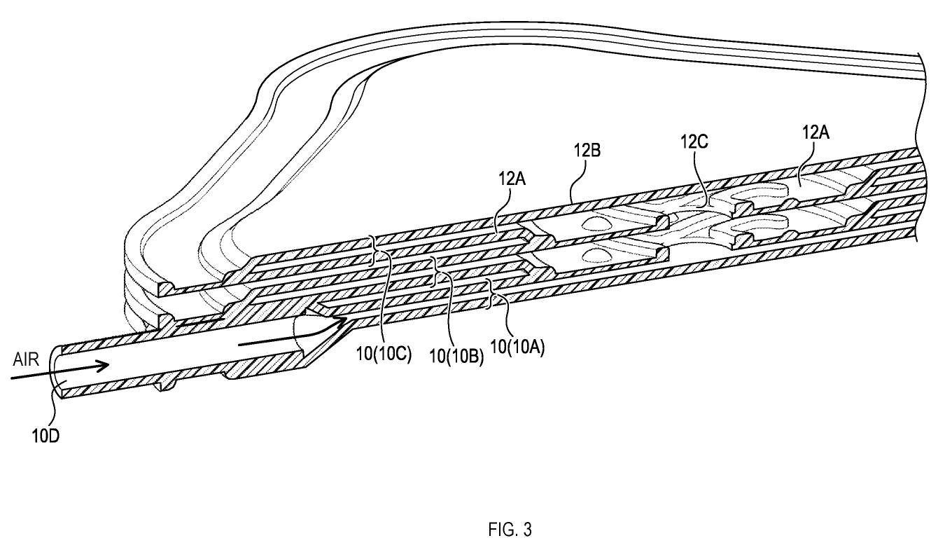

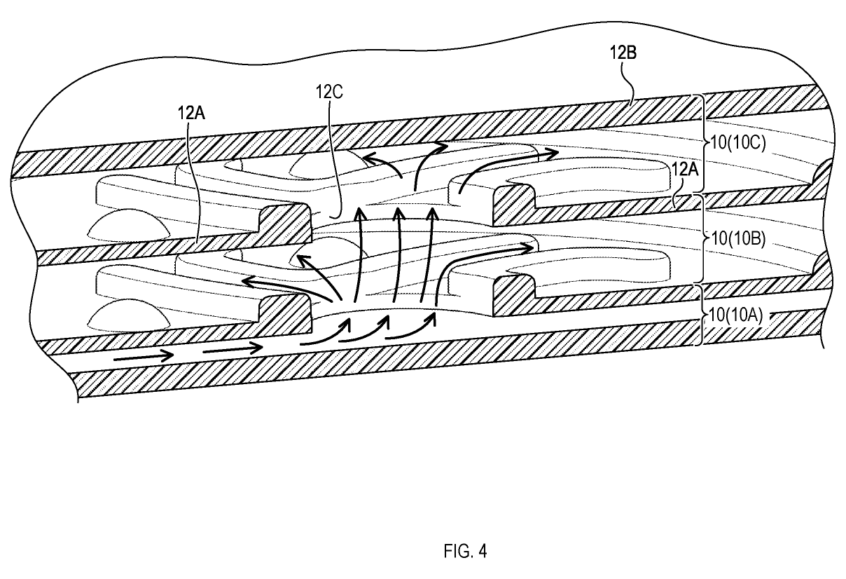

A flow port 10D extends from the outer edge of the air bladder 10A that is arranged on a first-end side in the direction of the stacked air bladders 10A to 10C (at the lowest in FIG. 2). The high-pressure air is supplied from the flow port 10D into the air bladder 10A (see FIG. 3). Air that has entered the air bladder 10A flows into each air bladder 10 from the air bladder 10 arranged on the first-end side (see FIG. 4) and then another.

### 2.2 Details of Air Bladder

In the present embodiment, an air bladder according to the present disclosure is applied to the air bladders 10B and 10C. The following description describes the air bladder according to the present disclosure using the air bladder 10C as an example. In the following description, the air bladder 10C is simply referred to as “air bladder 10”.

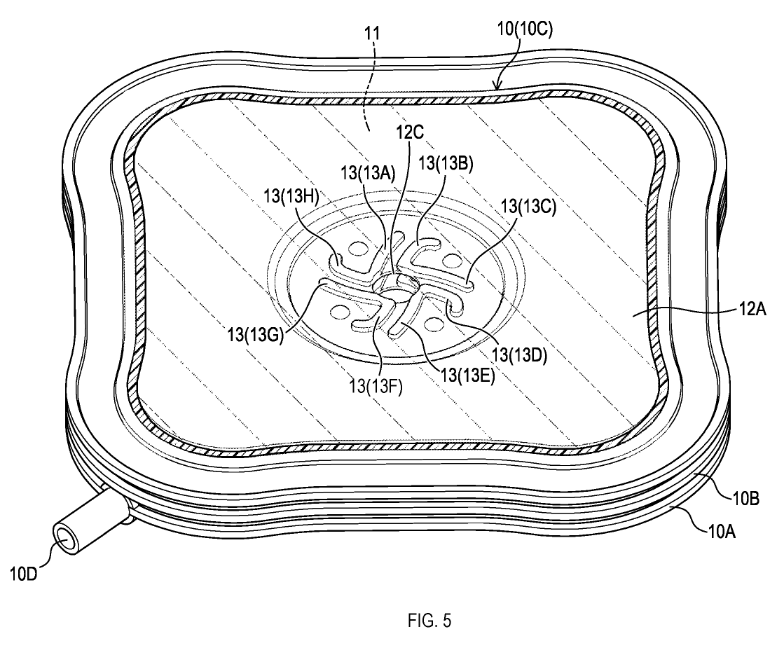

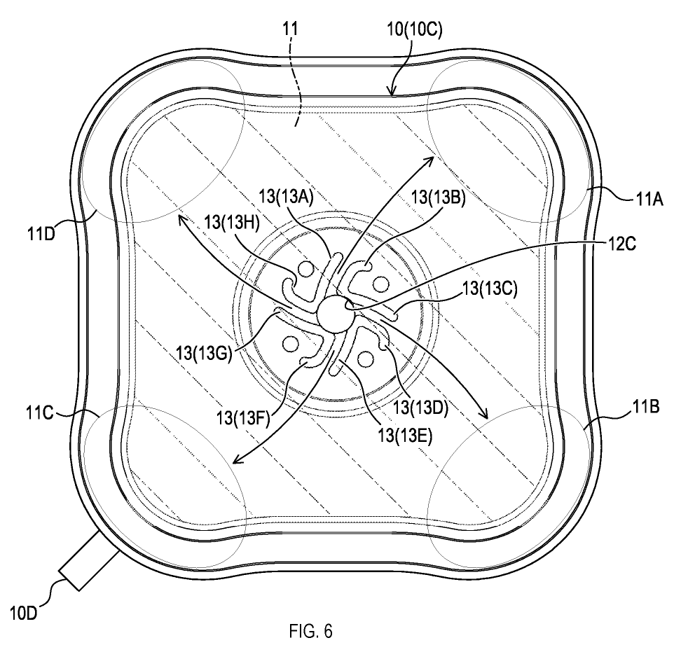

As shown in FIG. 5, the air bladder 10 according to the present embodiment includes an air chamber 11 (the portion shaded with two-dotted chain lines in FIG. 5) having a flat polygonal shape and configured to be filled with air. As shown in FIG. 6, the air chamber 11 according to the present embodiment has a substantially rectangular shape (quadrangular shape) with rounded corner portions 11A to 11D.

The description “the air chamber 11 … having a flat …shape” means that the air chamber 11 has a dimension parallel to the direction along the thickness (to be referred to as “thickness direction”) of a below-described sheet member 12A smaller than the dimension parallel to a direction perpendicular to the thickness direction.

The description “the air chamber 11 having a … polygonal shape” means that the shape of the perimeter of the air chamber 11 projected on a hypothetical plane orthogonal to the thickness direction is substantially polygonal. In other words, the corner portions 11A to 11D correspond to the four respective corner portions of the air chamber 11 formed in a substantially rectangular shape (quadrangular shape).

As shown in FIG. 3 and FIG. 4, the air chamber 11 is a space between two sheet members 12A and 12B (in other words, a first portion and a second portion, respectively) arranged in a face-to-face manner. Of the two sheet members 12A and 12B, the sheet member 12A includes a communication hole 12C in its central portion.

The sheet member 12A is a flexible member in the form of a film (or a plate) that separates the air chamber 11 of the air bladder 10 (the air bladder 10C) from the air chamber of the adjacent air bladder 10B. The communication hole 12C is a through hole that provides communication between the air chamber 11 and the air chamber of the air bladder 10B.

As shown in FIG. 5, the sheet member 12A includes two or more guide portions 13 (eight guide portions 13A to 13H in the present embodiment) located adjacent to the air chamber 11 side of the sheet member 12A. Each guide portion 13 is an elongated protrusion configured to guide air that flows into the air chamber 11 from the communication hole 12C toward an associated corner portion among the corner portions 11A to 11D of the air chamber 11.

Specifically, as shown in FIG. 6, the guide portions 13A and 13B guide air toward the corner portion 11A. The guide portions 13C and 13D guide air toward the corner portion 11B. The guide portions 13E and 13F guide air toward the corner portion 11C. The guide portions 13G and 13H guide air toward the corner portion 11D.

Each guide portion 13 is formed of the elongated protrusion extending in a direction inclined with respect to the radial direction of the communication hole 12C. The elongated protrusion is located on an interior-facing surface of the sheet member 12A facing the air chamber 11. The radial direction of communication hole 12C is a direction radially extending from the communication hole 12C (more specifically, from the center of the communication hole 12C, for example). Since the communication hole 12C according to the present embodiment has a circular shape, “the radial direction of the communication hole 12C” corresponds to a direction along the diameter of the communication hole 12C.

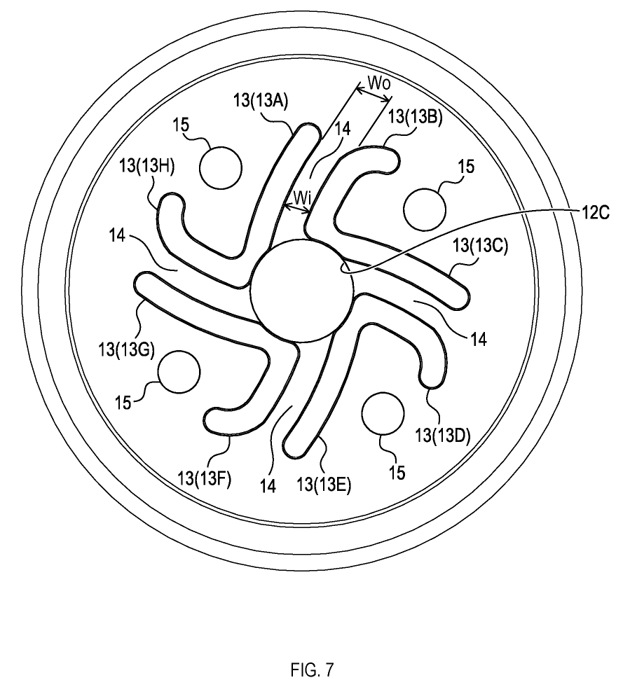

The elongated protrusion of each guide portion 13 is curved and extends in such a way as to form a vortex (more specifically, a leftward vortex, for example) around the communication hole 12C. In other words, when each elongated protrusion is viewed from, for example, the communication hole 12C along the sheet members 12A and 12B, each elongated protrusion is formed such that the tip is located on the right side of the root end, for example. The root end of the elongated protrusion refers to the end adjacent to the communication hole 12C. The tip refers to the end opposite from the root end. Hereinafter, when each elongated protrusion is viewed in a similar manner, the side on which the tip of each elongated protrusion is located will be referred to as a first side, and the side on which the root end is positioned is referred to as a second side. As shown in FIG. 7, each pair of two adjacent guide portions 13 defines an airflow path 14, and the airflow path 14 has an outlet width Wo larger than an inlet width Wi.

Specifically, of the two adjacent guide portions 13 (for example, the guide portions 13A and 13B) defining the air flow path 14, the guide portion 13B, located on the first side, has a portion near the tip that is curved to a greater degree toward the first side compared with the guide portion 13A on the second side.

A cross-sectional area of the airflow path 14 is selected so that the airflow in the airflow path 14 is laminar. This is to inhibit generation of turbulence, which is one of the causes of noise. The cross-sectional area of the airflow path 14 is the product of the width of the airflow path 14 and the protruding dimension of the guide portion 13 (in other words, the elongated protrusion).

In the range of the airflow path 14 from its inlet side to its outlet side, there is no member that obstructs the airflow. In other words, there is no wall-shaped portion in the airflow path 14 that intersects air flow lines.

The sheet member 12A includes one or more protruding portions 15 (four protruding portions 15, in the present embodiment). Each protruding portion 15 is arranged on a hypothetical circle that passes the tip of each guide portion 13 on the interior-facing surface of the sheet member 12A, and protrudes in the same direction as the guide portions 13. The protruding dimension of each protruding portion 15 is smaller than or equal to the protruding dimension of each guide portion 13.

### 3. Features of Air Bladder of Present Embodiment

In the air bladder 10 according to the present embodiment, air that flows into the air chamber 11 from the communication hole 12C is guided to the corner portions 11A to 11D of the air chamber 11 by the respective guide portions 13. This configuration makes it possible to reliably inflate the corner portions 11A to 11D, which are difficult to inflate, and thus possible to smoothly inflate the air bladder 10.

As the communication hole 12C is located at the center of the air chamber 11, the distance between each of the corner portions 11A to 11D and the communication hole 12C is longer than the distances between other portions and the communication hole 12C. To resolve this issue, the present embodiment provides a configuration in which air that flows into the air chamber 11 from the communication hole 12C is guided to the corner portions 11A to 11D of the air chamber 11 by the respective guide portions 13.

Thus, it is possible to inhibit air from being filled into the air chamber 11 at uneven pressures. This allows the air pressure in the air chamber 11 to rise in a substantially uniform manner. Thus, it is possible to uniformly and smoothly inflate the entire air bladder 10.

Each guide portion 13 is formed of the elongated protrusion extending in a direction inclined with respect to the radial direction of the communication hole 12C. This makes it possible to provide an extended length to the elongated protrusion of each guide portion 13 in the air bladder 10.

Thus, when a load to flatten the air chamber 11 is applied to the air bladder 10, it is possible to inhibit an instance where, for example, the sheet members 12A and 12B come into contact with each other, and the communication hole 12C is thereby closed by the sheet member 12B.

In this configuration, the guide portion 13 has a greater length compared with a case where a guide portion extends in the radial direction. Thus, even when a load to flatten the air chamber 11 is applied to the air bladder 10, it is possible to sufficiently bear the load.

Even when a load to flatten the air chamber 11 is applied to the air bladder 10, it is possible to inhibit the sheet members 12A and 12B from coming into contact with or adhering to each other. Thus, it is possible to reliably supply air into the air chamber 11 from the communication hole 12C, and to quickly inflate the air bladder 10.

Furthermore, the elongated protrusion of each guide portion 13 extends in such a way as to form a vortex around the communication hole 12C. This creates a swirling component in the airflow toward the corner portions 11A to 11D in addition to components toward the respective corner portions 11A to 11D.

Air that has reached the corner portions 11A to 11D readily changes its direction due to the swirling component. Thus, it is possible to effectively generate the Coandă effect. This configuration enables air to be distributed throughout the air chamber 11, thus enabling the air bladder 10 to be smoothly and quickly inflated.

The outlet width Wo of the airflow path 14 is larger than the inlet width Wi. This configuration serves as a diffuser, increasing air pressure at the outlet side of the airflow path 14. Thus, it is possible to reliably distribute air throughout the air chamber 11.

### Second Embodiment

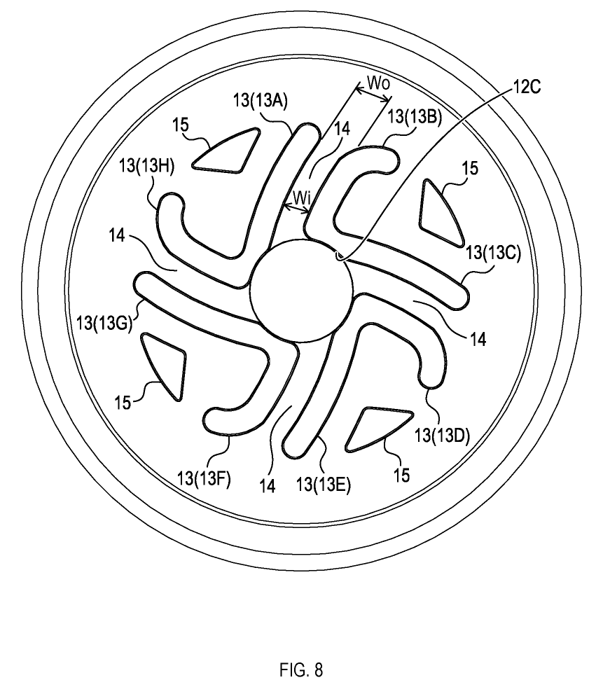

In the first embodiment, each protruding portion 15 has a hemispherical shape. As shown in FIG. 8, each protruding portion 15 has a polygonal (in FIG. 8, triangular) shape in the present embodiment.

The same elements and so on as in the aforementioned embodiment are assigned with the same reference numerals as in the aforementioned embodiment. Thus, the same explanations are not repeated in the present embodiment.

### Third Embodiment

In the aforementioned embodiments, the protruding portions 15 are formed separately from the respective guide portions 13. The protruding portions 15 according to the present embodiment are elongated protrusions, which are similar to those of the guide portions 13, and formed integrally with the guide portions 13.

The same elements and so on as in the aforementioned embodiments are assigned with the same reference numerals as in the aforementioned embodiments. Thus, the same explanations are not repeated in the present embodiment.

### Fourth Embodiment

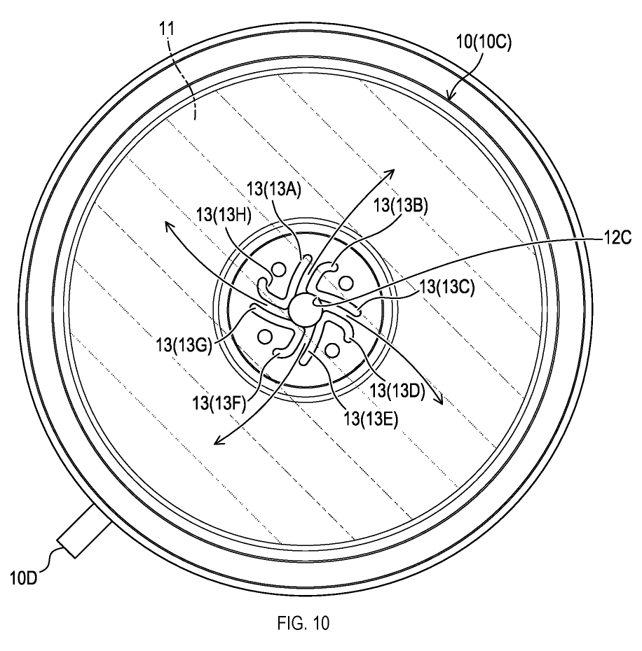

In the aforementioned embodiments, the air chambers have a flat polygonal shape. The air chamber 11 according to the present embodiment has a flat circular (see FIG. 10) or a flat oval shape.

In the present embodiment, the guide portions 13 guide air that flows into the air chamber 11 from the communication hole 12C toward the outer periphery of the air chamber 11. This can inhibit air from being filled into the air chamber 11 at uneven pressures as in the aforementioned embodiments.

This allows the air pressure in the air chamber 11 to rise in a substantially uniform manner, and thus it is possible to inflate the entire air bladder 10 uniformly and smoothly. The same elements and so on as in the aforementioned embodiments are assigned with the same reference numerals as in the aforementioned embodiments. Thus, the same explanations are not repeated in the present embodiment.

### Other Embodiments

In the aforementioned embodiments, the air chamber 11 has a polygonal shape with the rounded corner portions 11A to 11D. However, the present disclosure is not limited to this configuration. For example, each corner portion may be chamfered, or non-chamfered.

In the aforementioned embodiments, each guide portion 13 is inclined with respect to the radial direction of the communication hole 12C in such a way as to form a leftward vortex. However, the present disclosure is not limited to this configuration. For example, each guide portion 13 may be inclined with respect to the radial direction of the communication hole 12C in such a way as to form a rightward vortex. In other words, when each elongated protrusion is viewed, for example, from the communication hole 12C along the sheet members 12A and 12B, each elongated protrusion may be formed such that the tip is located on the left side of the root end, for example.

Each guide portion 13 according to the aforementioned embodiments is inclined with respect to the radial direction of the communication hole 12C. However, the present disclosure is not limited to this configuration. Each guide portion 13 may extend linearly in the radial direction, for example.

The communication hole 12C according to the aforementioned embodiments is a round hole. However, the present disclosure is not limited to this configuration. The communication hole 12C may have, for example, a polygonal shape. The radial direction of the polygonal communication hole 12C refers to an outward direction from the center of the communication hole 12C.

Each guide portion 13 according to the aforementioned embodiments is curved and extends in such a way as to form a vortex around the communication hole 12C. However, the present disclosure is not limited to this configuration. Each guide portion 13 may extend linearly, for example.

In the aforementioned embodiments, the air bladders 10A to 10C are stacked, forming the air bladder set. However, the present disclosure is not limited to this configuration. The air bladder set may consist of the air bladder 10C or the air bladder 10B, for example.

In the aforementioned embodiments, the air bladders 10A to 10C are stacked, forming the air bladder set, and the air bladder 10C and the air bladder 10B have the same configuration. However, the present disclosure is not limited to this configuration.

In the aforementioned embodiments, the air bladders 10A to 10C are installed inside the seatback 3. However, the present disclosure is not limited to this configuration. The air bladders 10A to 10C may be installed inside the seat cushion 2, for example.

In the aforementioned embodiments, the air chamber 11 is provided with four airflow paths 14 because of its substantially rectangular shape (quadrangular shape). However, the present disclosure is not limited to this configuration. The air chamber 11 may be provided with at least one airflow path 14.

In the aforementioned embodiments, the air chamber 11 has a substantially rectangular shape (quadrangular shape). However, the present disclosure is not limited to this configuration. The air chamber 11 may have, for example, three corner portions, or five or more corner portions.

The air bladder 10 according to the aforementioned embodiments is for use to provide a refreshing effect to an occupant. However, the present disclosure is not limited to this use. The present disclosure is applicable, for example, to an air bladder for maintaining a posture of the occupant.

In the aforementioned embodiments, the vehicle seat of the present disclosure is applied to a car. However, the application of the present disclosure is not limited thereto. In other words, the present disclosure may be applied to a seat used in vehicles such as railroad vehicles, ships and boats, and aircrafts, and also to a stationary seat used in theaters and households, for example.

Furthermore, the present disclosure is only required to coincide with the gist of the disclosure described in the aforementioned embodiments and thus should not be limited to the aforementioned embodiments. Therefore, the present disclosure may include a configuration obtained by combining at least two of the aforementioned embodiments, or a configuration obtained by eliminating part of the elements in the drawings or the elements described with reference numerals in the aforementioned embodiments.

What is claimed is:

1. An air bladder for use in a vehicle seat, the air bladder comprising:
an air chamber having a flat polygonal shape and configured to be filled with air;
a sheet member separating the air chamber from an exterior;
a communication hole formed in a central portion of the sheet member, the communication hole allowing communication between the air chamber and the exterior; and
at least one guide portion located adjacent to an air chamber side of the sheet member, the at least one guide portion being configured to guide air that flows into the air chamber from the communication hole toward a corner portion of the air chamber.

2. The air bladder according to claim 1, wherein
each of the at least one guide portion is formed as an elongated protrusion on an interior-facing surface of the sheet member, the interior-facing surface facing the air chamber, and
the elongated protrusion extends in a direction inclined with respect to a radial direction of the communication hole.

3. The air bladder according to claim 2, wherein the elongated protrusion extends in such a way as to form a vortex around the communication hole.

4. An air bladder for use in a vehicle seat, the air bladder comprising:
an air chamber configured to be filled with air;
a sheet member separating the air chamber from an exterior;
a communication hole formed in a central portion of the sheet member, the communication hole allowing communication between the air chamber and the exterior; and
at least one guide portion located adjacent to an air chamber side of the sheet member, the at least one guide portion being configured to guide air that flows into the air chamber from the communication hole toward an outer periphery of the air chamber,
each of the at least one guide portion being formed as an elongated protrusion on an interior-facing surface of the sheet member, the interior-facing surface facing the air chamber, and
the elongated protrusion extending in a direction inclined with respect to a radial direction of the communication hole.

5. The air bladder according to claim 4, wherein the elongated protrusion extends in such a way as to form a vortex around the communication hole.

6. The air bladder according to claim 4, wherein the air chamber is flat.

7. The air bladder according to claim 2, wherein
the sheet member includes a first portion and a second portion arranged to face each other with the air chamber interposed therebetween,
the communication hole is formed in a central portion of the first portion, and
the at least one guide portion is located on the interior-facing surface of the first portion.

8. The air bladder according to claim 1, wherein
the at least one guide portion includes a plurality of guide portions, and
two adjacent guide portions of the plurality of guide portions define an airflow path, the airflow path having an outlet width larger than its inlet width.

9. An air bladder set for use in a vehicle seat, the air bladder set comprising:
an air bladder according to claim 1; and
an additional air bladder including a different air chamber configured to be filled with air, and a different sheet member separating the different air chamber from an exterior, the different air chamber and the different sheet member being respectively different from an air chamber and a sheet member of the air bladder,
the air chamber of the air bladder and the different air chamber of the additional air bladder being connected via a communication hole of the air bladder.

10. The air bladder set according to claim 9, further comprising a flow port extending from the different sheet member to allow air to be supplied to the air chamber and the different air chamber.
